(19) United States
(12) Patent Application Publication
(10) Pub. No.: US 2016/0245981 A1
(43) Pub. Date: Aug. 25, 2016

(54) LIGHT-EMITTING PANEL FOR GAME CONSOLE

(71) Applicant: Yi-Ho Lin, Kaohsiung City (TW)

(72) Inventor: Yi-Ho Lin, Kaohsiung City (TW)

(21) Appl. No.: 14/968,912

(22) Filed: Dec. 15, 2015

(30) Foreign Application Priority Data
Feb. 16, 2015 (TW) 104202608

(51) Int. Cl. F21V 8/00; G07F 17/32

(52) U.S. Cl. CPC G02B 6/0043; G07F 17/3216; G02B 6/005

(57) ABSTRACT

A light-emitting panel for a game console includes a frame, light-emitting lamp bars, a light guiding plate and a light passing plate, where accommodation grooves which light-emitting lamp bars is inserted are configured on the frame; the lateral margin of the light guiding plate is inserted and fixed in the accommodation grooves of the framed and a plurality of light guiding mesh points are printed on the front side thereof; and the lateral margin of the light passing plate is inserted and fixed in the accommodation grooves of the frame, and positioned in front of the light guiding plate. Whereby, the present invention provides a panel structure allowing the panel of a game console to illuminate uniformly and be more eye-appealing.

### TECHNICAL FIELD OF THE INVENTION

The present invention relates to a light-emitting panel for a game console, and more particularly to a panel structure allowing the panel of the game console to illuminate uniformly and be more eye-appealing.

### DESCRIPTION OF THE PRIOR ART

To make game consoles more eye-appealing and eye-catching, a light-emitting panel is always configured on the console body of the game console; a striking advertisement, pattern, slogan and so on are configured on the panel together with the visual experience of dazzling brilliance being generated thereby, thereby attracting players.

The light-emitting panels of such game consoles mentioned above are mainly configured with several lamp tubes at the rear side of a light-passing plate, and a advertisement, pattern, slogan and etc may then be configured on the front side of the light-emitting plate in such a way to illuminate the advertisement, pattern and slogan by means of the light emitted from the lamp tubes. However, the parts of the light-emitting panel close to the lamp tubes are brighter and other parts thereof far away from the lamp tubes are dimmer if the tube lamps are too few to make light not bright enough because the brightness of a such kind of light-emitting panel depends on the number and brightness of the lamp tubes, causing the brightness of the light-emitting panel to be not uniform, and therefore to form a brightness gradient to make the panel not eye-appealing and enjoyable, and further to influence players' desire to play.

To solve the drawbacks mentioned above, the industry installs a larger number of lamp tubes or replaces the lamp tubes with higher power ones to make the brightness of the light-emitting panel more uniform. But, it is necessary to spend more power to do so, resulting in the defect of causing the cost to be higher. In addition, the light-emitting panel so manufactured is brighter, apt to cause players to feel uncomfortable because the light is too bright to be too harsh to the eye and to make them dizzy.

### SUMMARY OF THE INVENTION

The object of the present invention is to provide a light-emitting panel for a game console, allowed to illuminate uniformly and be more eye-appealing.

To achieve the above object, the present invention proposes a light-emitting panel for a game console, including:

A frame, configured around the lateral margins of a light guiding plate and light passing plate, accommodation grooves being configured thereon, the accommodation grooves providing the accommodation of light-emitting lamp bars and the insertion of the lateral margins of the light guiding plate and light passing plate therein;

the light-emitting lamp bars, inserted in the accommodation groove of the frame, a plurality of light-emitting elements being respectively configured thereon;

the light guiding plate, being a transparent plate made from transparent acrylic material, the peripheral edge of the light guiding plate being inserted and fixed in the accommodation groove of the frame, a plurality of light guiding mesh points being printed on the light guiding plate, and the light guiding mesh points being printed on the light guiding plate with light guiding ink by means of screen printing;

The light passing plate, made from acrylic material, the peripheral edge of the light passing plate being inserted and fixed in the accommodation groove of the frame and configured in front of the light guiding plate, and the light passing plate being smaller than the light guiding plate in thickness.

Whereby, the present invention provides a panel structure allowing the panel for a game console to illuminate uniformly and be eye-appealing.

### BRIEF DESCRIPTION OF THE DRAWINGS

FIG. 1 is an exploded view of the present invention;

FIG. 2 is a partly cross-sectional view of the present invention; and

FIG. 3 is a schematic view of the travel routes of light emitted from light-emitting light bar according to the present invention.

### DETAILED DESCRIPTION OF THE PREFERRED EMBODIMENTS

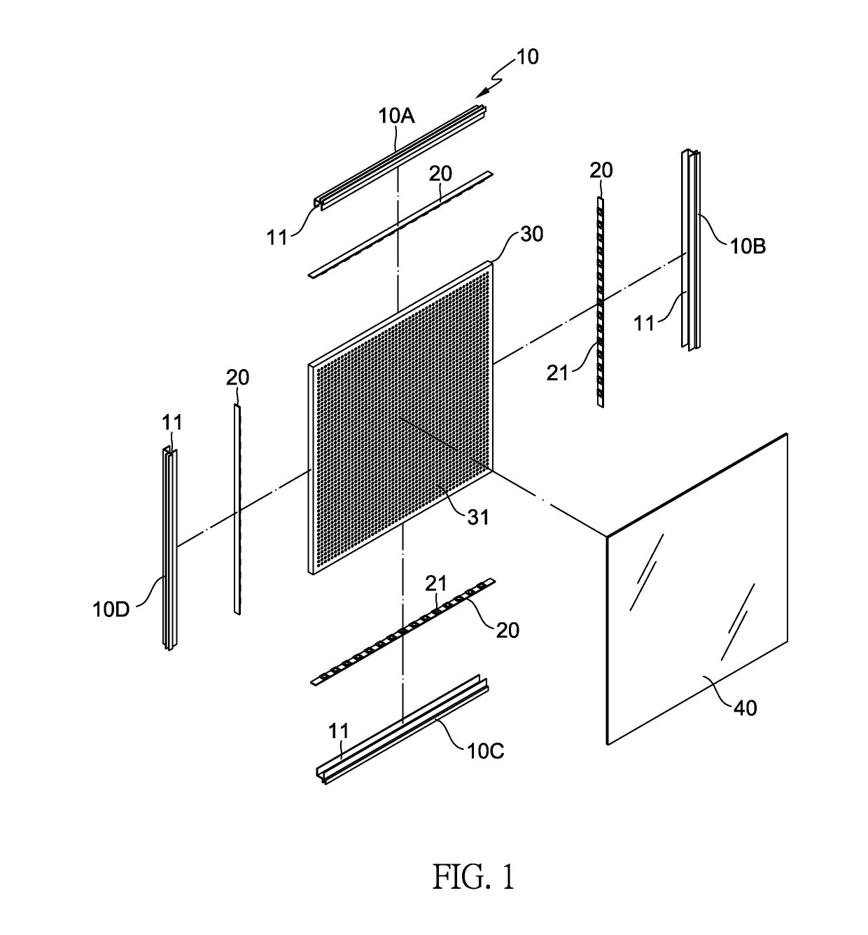

Referring to FIG. 1, a light-emitting panel for a game console in a preferred embodiment according to the present invention includes a frame 10, light-emitting lamp bars 20, a light guiding plate 30 and a light passing plate 40.

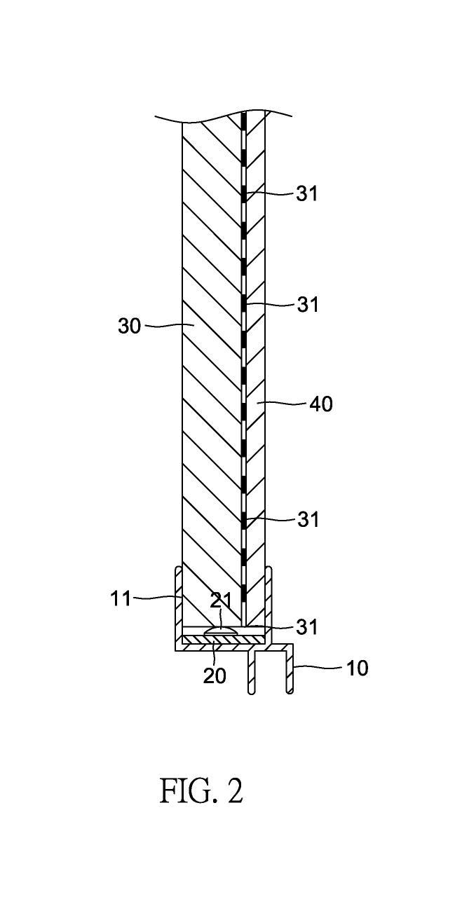

The frames 10, also referring to FIG. 2, is configure on the lateral margins of the light guiding plate 30 and light-passing plate 40, including four frame strips 10A, 10B, 10C and 10D, which can be combined together to form the frame 10, where an accommodation groove 11 is respectively configured on the frame bars 10A, 10B, 10C and 10D for the accommodation of the light-emitting lamp bar 20 and the provision of the insertion of the lateral margins of the light guiding plate 30 and the one of the light passing plate 40 therein.

Also referring to FIG. 2, the light-emitting lamp bar 20, on which a plurality of light-emitting elements 21 are mounted, is inserted in the accommodation grooves 11 of the frame 10.

Preferably, the light-emitting lamp bar 20 is a color changeable lamp bar, and the light-emitting element 21 is an LED lamp.

The light guiding plate 30, also referring to FIG. 2, is a transparent plate made from transparent acrylic material, and the peripheral edge of the light guiding plate 30 is inserted in the accommodation grooves 11 of the frame 10, with the front side of the guiding plate 30 being printed with a plurality of light guiding mesh points made of light-emitting ink by means of screen printing, where the thickness of the light guiding plate 30 is preferably the same as the width of the light emitting element 21.

The light passing plate 40, also referring to FIG. 2, is a light passing plate body made from acrylic material, and the peripheral edge of the light passing plate 40 is inserted and fixed in the accommodation grooves 11 of the frame 10, where the light passing plate is positioned in front of the light guiding plate 30. Furthermore, the thickness of the light passing plate 40 is smaller than the one of the light guiding plate 30.

The light passing plate 40 preferably is a white plate body.

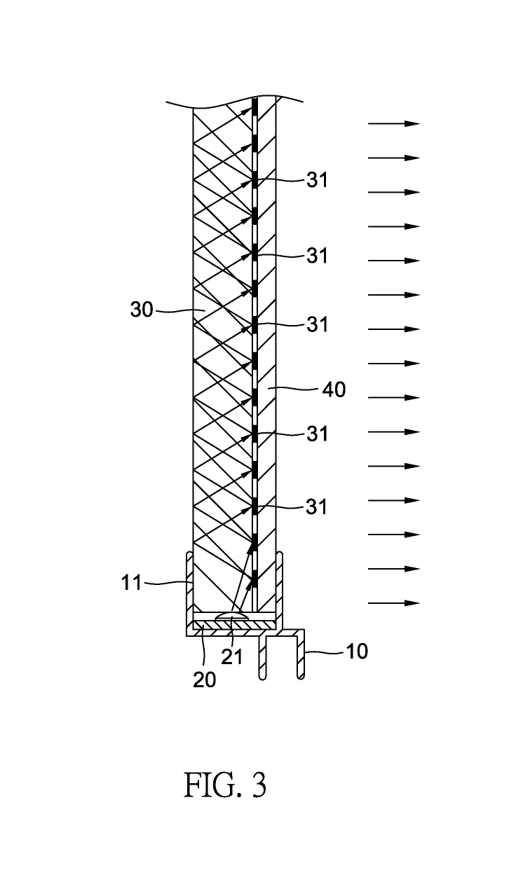

By means of the structures mentioned above, referring to FIG. 3, when light emitted from the light emitting element 21 of the light-emitting lamp bar 20 illuminates from the lateral margin of the light guiding plate 30, the light beams inside the light guiding plate 30 can be reflected by the light guiding mesh points 31 to change the angles and directions at and in which the light beams are projected out because the plurality of light guiding mesh points 31 are configured on the light guiding plate 30, allowing the light beams to be scattered uniformly at all angles so as to guide the light beams uniformly to the light guiding plate 30, and further allowing the light guiding plate 20 to illuminate uniformly. At the same time, the light beams from the light guiding plate 30 can be softened and reflected again back to the light guiding plate 30 through the light passing plate 40 configured in front of the light guiding plate 30. Thereafter, the light beams can be further reflected and scattered by the light guiding mesh points 31, allowing the light beams emitted from the light passing plate 40 to be more uniform, soft and bright.

Therefore, from the above, it can be clearly seen that the present invention has the following advantages:
1. because the plurality of light guiding mesh points 31 made of light guiding ink, are configured on the light guiding plate 30 according to the present invention, the light guiding mesh points 31 can reflect and scatter light beams in all directions uniformly upon the illumination of the light beams, the light beams in the light guiding plate 30 can be reflected continuously and then diffused, allowing the light guiding plate 30 to illuminate uniformly to obtain the overall brightness uniformity. As a result, the present invention will not produce brightness gradient and further improve the panel appearance and significance.
2. because the light-emitting lamp bars 20 are configured on the lateral margin of the light guiding plate 30 with the frame 10 according to the present invention, the light-emitting lamp bars 20 illuminating synchronously from the lateral margin of the light guiding plate 30 allows the light guiding plate 30 to be lighted uniformly, and the light beams being reflected by the light guiding mesh points 31 allows the light reflection effect of the light guiding plate 30 to be improved indeed, and the brightness of the panel and the uniformity of the light beams to be further increased.
3. furthermore, because the light passing plate 40, which is a white plate body, is configured in from of the light guiding plate 30, it can reflect the light beams scattered from the light guiding plate 30 increasingly to improve the brightness of the light beams, and soften the light beam to prevent the panel from being too bright and harsh to the eye. In addition, the light passing plate 40 can also block the light guiding mesh points 31 configured on the light guiding plate 30 so as to prevent players from looking steadily at the mesh points 31, further making panel more eye-appealing.
4. the light beams emitted from the light elements 21 of the light-emitting lamp bars 20 configured on the light guiding plate 30 are reflected by the light guiding mesh points 31 configured on the lateral margin of the light guiding plate 30, allowing the light guiding plate 30 to illuminate, thereby needing no configuration of the too many or high power light-emitting elements 21, and therefore, having the merits of saving energy and cost.

I claim:

1. A light-emitting panel for a game console, comprising:
a frame, configured with accommodation grooves for the accommodation of light-emitting lamp bars and allowing the insertion of lateral margins of a light guiding plate and light passing plate therein;
said light-emitting lamp bars, inserted in said accommodation grooves of said frame, and a plurality of light emitting elements being respectively thereon;
said guiding plate, being a transparent plate made from transparent acrylic material, a peripheral edge of said light guiding plate being inserted and fixed in said accommodation grooves of said frame, and a plurality of light guiding mesh points being printed on a front side of said light guiding plate, said light guiding mesh points being printed on said light guiding plate with light guiding ink by means of screen printing; and
said light passing plate, made from acrylic material, a peripheral edge of said light passing plate being inserted and fixed in said accommodation grooves of said frame and configured in front of
said light guiding plate, said light passing plate is smaller than said light guiding plate in thickness;
thereby allowing said panel to illuminate uniformly and be more eye-appealing.

2. The panel according to claim 1, wherein said frame is constituted by four frame strips.

3. The panel according to claim 1, wherein said light-emitting lamp strip is a color changeable lamp strip.

4. The panel according to claim 1, wherein said light-emitting element is an LED lamp.

5. The panel according to claim 2, wherein said light-emitting element is an LED lamp.

6. The panel according to claim 1, wherein a thickness of said light guiding plate is the same as a width of said light-emitting element.

7. The panel according to claim 1, wherein said light passing plate is a white plate body.
